(19) United States
(12) Patent Application Publication
(10) Pub. No.: US 2002/0176980 A1
(43) Pub. Date: Nov. 28, 2002

(54) Interior covering element for a vehicle and method for producing the same

(76) Inventor: Dominique Marcovecchio, Asnieres Sur Seine (FR)

Correspondence Address: ROTHWELL, FIGG, ERNST & MANBECK, P.C., 1425 K STREET, N.W., SUITE 800, WASHINGTON, DC, 20005, US

(21) Appl. No.: 09/889,894

(22) PCT Filed: Dec. 8, 2000
(86) PCT No.: PCT/FR00/03452

(30) Foreign Application Priority Data
Dec. 9, 1999 (FR) 99/15548

(51) Int. Cl. B32B 3/26; B32B 3/00

(52) U.S. Cl. 428/316.6; 428/314.4; 425/112

(57) ABSTRACT

The invention concerns a vehicle interior trim element and process for manufacturing same.

In accordance with the invention, the vehicle interior trim element (1) comprises:

a rigid core member (3) which gives the element its shape,

a cover sheet (11) of fabric or similar which covers the rigid core member,

a foam layer (13, 14) arranged between the rigid core member and the cover sheet, and subdivided into a first and a second under-layer such that:

the first under-layer (13) has mainly open cells and is arranged between the cover sheet and the second under-layer, and

the second under-layer (14) is produced from thermoplastic polyolefin material(s), has mainly closed cells and is arranged between the core member and the first under-layer.

Accordingly the appearance, feel and sound of the element are improved.

The invention is concerned with a vehicle interior trim element and with the process for manufacturing same.

Such elements are fitted onto the interior of the vehicle body. They usually have a rigid core member which gives the element its shape, and a cover sheet overlaying the rigid core member so as to constitute the visible surface of the panel. In order to give these elements a softer feel, a layer of foam is interposed between the rigid core member and the cover sheet.

However, although a number of processes (e.g. injection, compression, thermo-compression) and types of foam (e.g. polyolefin, polyurethane) have been proposed for producing such elements, none has really proved satisfactory in the case of an element presenting distinct configurations such as an elbow rest, which needs to be covered with a fabric or similar (e.g. a fibre-based non-woven material). A distinction is made here between fabrics (notably woven, pile, knitted, non-woven fabrics, etc.) and hides, whether natural (leather) or synthetic (PVC, polyolefin, etc.).

As regards the type of foam used, a foam having substantially open cells, even in the case of a foam comprising essentially polyurethane, where used in a layer more than a few tenths of a millimetre thick, needs to be stretched in order to prevent creases from forming. This considerably lessens its compressibility, particularly in the convex areas where this is virtually zero.

As for a foam with essentially closed cells, even in the case of a foam composed essentially of a thermoplastic polyolefin material, where the cover sheet is made of fabric or similar, this does not generally allow a totally satisfactory part to be obtained. The reason for this is that the part obtained then has unflattering acoustic characteristics (being noisy and sounding like cardboard) and is very often considered to have an unpleasant feel (harsh and abrasive to the touch) and to be too hard for some applications (notably door panels).

For practical purposes it can be said that a foam having closed cells contains air inside these cells. The air is then compressed whenever the foam is crushed. Conversely, an open-cell foam allows air to escape when it is compressed.

EP-A-0 446 411 discloses a trim element the foam layer of which is sub-divided into a first soft under-layer of polyolefin (TPO) or polyvinyl chloride (PVC) and a second under-layer of high-density polyurethane (PU), the first under-layer being arranged between the cover sheet and the second under-layer, while the second under-layer is arranged between the first under-layer and the core member.

The second foam under-layer forms a thermal barrier which prevents deterioration of the first foam under-layer and thus makes it possible to shape said first under-layer without creases forming.

However, this solution is not entirely satisfactory, to the extent that the aforementioned defects regarding the perceived quality of the product in terms of its feel and its acoustic response are still appreciable.

The invention aims to improve the quality of the trim element by eliminating or at least very markedly reducing the aforementioned problems, whilst at the same time permitting convenient, inexpensive implementation.

To do this, the invention proposes that:

the first under-layer have mainly open cells, and

the second under-layer have mainly closed cells and be made essentially of thermoplastic polyolefin material(s).

The second foam under-layer thus provides a certain softness to the touch over the whole part, even if this softness is limited. Furthermore, it gives the trim element a more pleasant sound than in the case where the second under-layer is made of high-density polyurethane.

Under a complementary feature, the invention proposes that the first foam under-layer be made essentially of polyurethane.

The open-cell polyurethane foam of the first under-layer improves the soft feel over the main area of the part, giving the fabric more freedom, notably than polyolefin (polypropylene or polyethylene) foam, with the result that it produces a sensation of greater softness to the touch and insulates the part for noise, thus giving it a duller sound, even where the foam is not very thick.

An attractive compromise between sound insulation, risk of creasing and cost of the trim element is achieved by making the first foam under-layer between 1 and 3 millimetres thick.

The invention is furthermore concerned with a process for producing a vehicle interior trim element.

EP-A-0 446 411 discloses a process comprising the following steps:

a) producing a structure comprising a cover sheet, a first foam under-layer having mainly open cells, and a second foam under-layer having mainly closed cells,

b) arranging the first foam under-layer in a mould, between the cover sheet and the second foam under-layer,

c) shaping the cover sheet, the first and the second foam under-layers by closing the mould,

d) joining the cover sheet, the first and the second foam under-layers with a rigid core member.

Accordingly, in a single operation, on the one hand the cover sheet, and the first and second foam under-layers are shaped and, on the other hand, they are joined to the rigid core member.

However, this process presents the aforementioned problems with regard to the trim element. In order to overcome these problems, the invention proposes that in step a) a structure is produced of which the second foam under-layer is essentially made of thermoplastic polyolefin material(s).

This solution has the advantages mentioned above with regard to the trim element.

In complementary fashion, the invention proposes that in order to carry out steps b), c) and d), the following steps are carried out in turn:

producing the core member beforehand,

arranging the core member in the mould, facing the second foam under-layer,

pressing on the cover sheet, the first foam under-layer, the second foam under-layer, and the core member, in order to shape them all and join them together.

Producing the core member beforehand lessens the risk of adversely affecting the qualities of the second foam underlayer.

In order to still further enhance the appearance of the finished element, the invention proposes that it be substantially given its final shape before the core member is arranged in the mould.

This means that only the unit made up of the cover sheet, and the first and second foam under-layers needs to be shaped while in the mould. Accordingly, the thickness requiring to be shaped is small in comparison to the thickness of the whole element. Consequently, as the foam under-layers and the cover sheet are subjected to fewer stresses there is less of a risk of them presenting visual flaws.

Under another complementary feature of the invention, in order to carry out steps c) and d) the following steps are carried out in turn:

arranging the structure in the mould,

at least partially closing the mould,

injecting plastic at low pressure against the second foam under-layer, via a plurality of nozzles.

Thus the element is produced in one operation fewer, since producing the core member, shaping the cover sheet, and the first and second foam under-layers, and joining them to the core member, is done in a single step.

The injection at low pressure makes it possible to reduce the risk of visual defect on the finished element, and in particular of damaging the foam under-layer with the mainly closed cells, by exposing it to lesser stresses. Injecting through a plurality of nozzles allows the injection temperature of the material to be lowered and the flow distances to be shortened. This makes it possible to improve the homogeneity of the thermal and mechanical stresses undergone by the structure and accordingly to reduce the risk of the flow lines being visible.

To still further enhance the appearance of the finished element and the join between the core member and the second foam under-layer, the invention proposes that prior to step c) the second foam under-layer be exposed to a heat source in order to soften it.

Heating helps to shape the second foam under-layer, reduces the risk of producing creases and improves the chemical bond with the core member, including in cases where a layer of glue is arranged between the core member and the second foam under-layer.

To facilitate the manufacture of the element and improve the join between the cover sheet, the first and the second foam under-layers, the invention proposes joining together the cover sheet, the first and the second foam under-layers prior to step b).

The structure constituted by the assembled unit of the cover sheet, and the first and second foam under-layers is more convenient to position in the mould than in the case where these layers have not been joined together beforehand. Moreover, the join between these layers can be controlled better when it is produced beforehand than when it is produced in the mould, with the core member present.

The invention will become clearer still from the following description, referring to the accompanying drawings wherein:

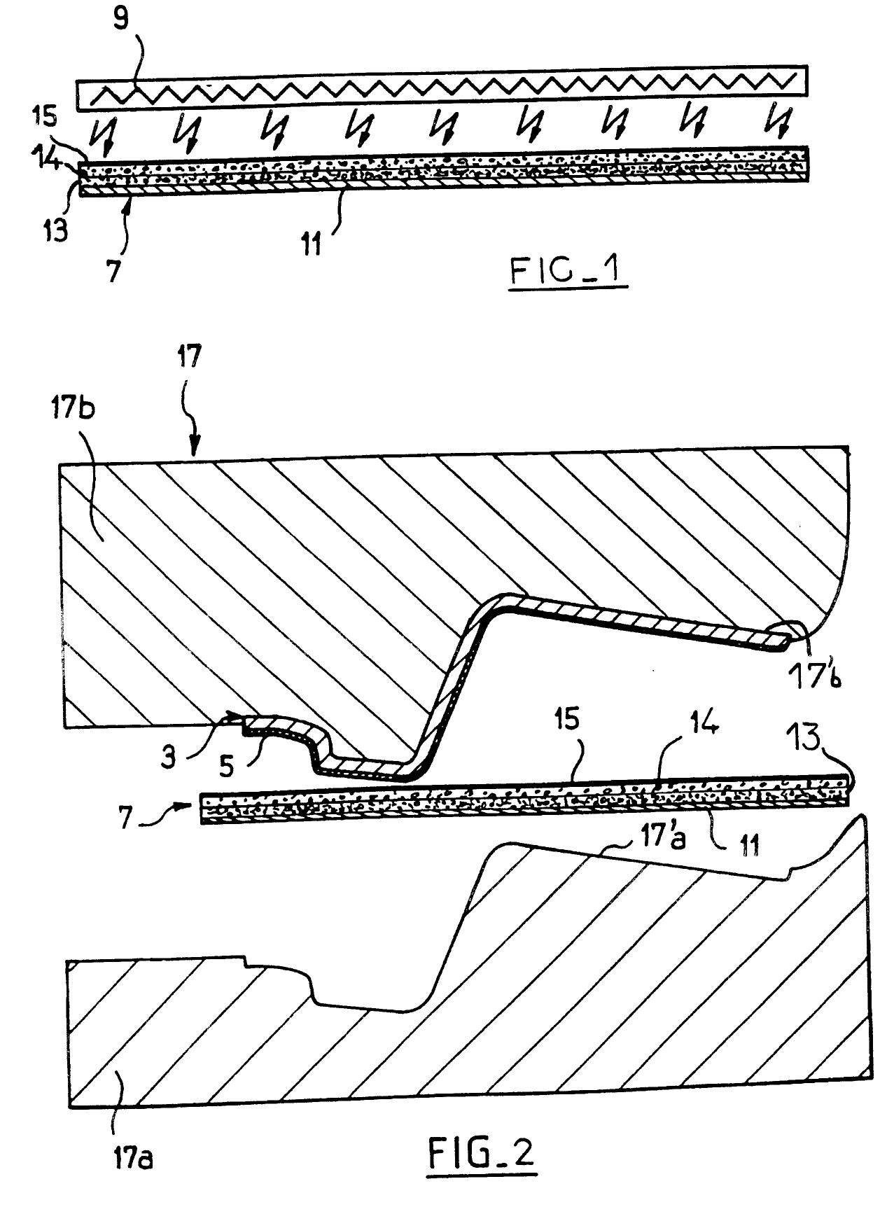

FIGS. 1 to 3 are sectional views illustrating three steps of a process in accordance with the invention;

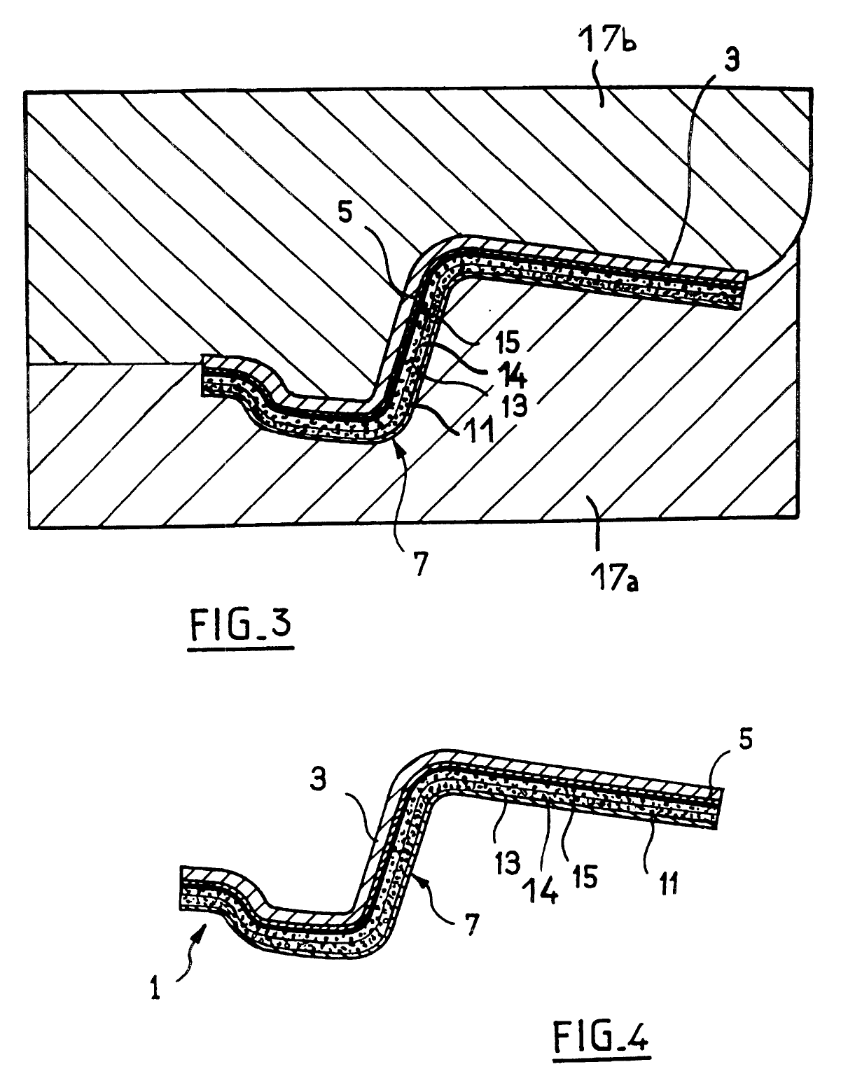

FIG. 4 is a sectional view of a vehicle interior trim element obtained by implementing the process outlined in FIGS. 1 to 3;

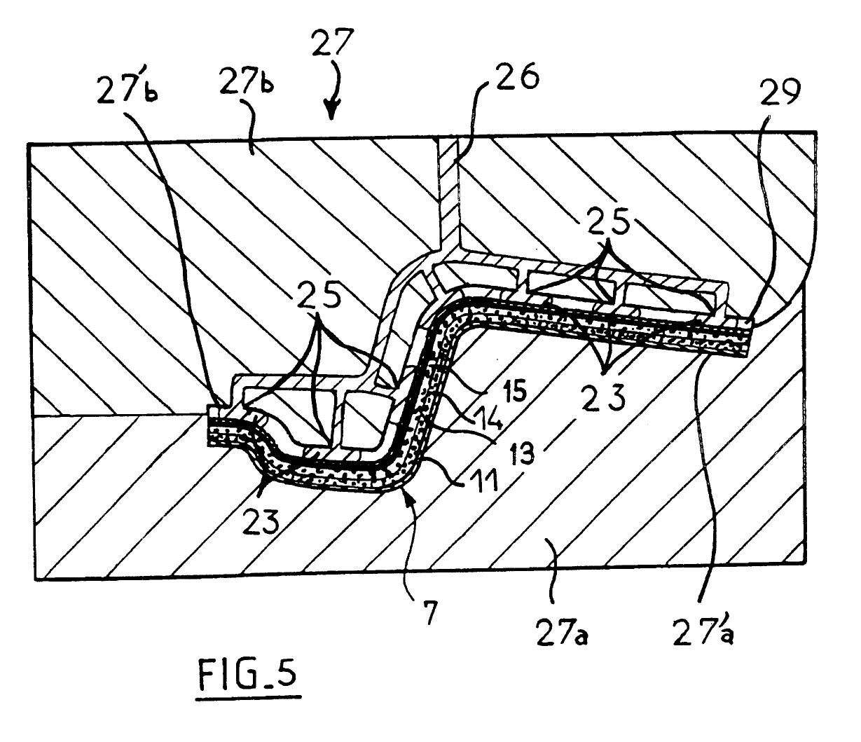

FIG. 5 is a sectional view of a variant of the process.

FIGS. 1 to 4 show a process for producing a vehicle interior trim element, specifically an inside door panel, said part being identified (schematically) overall as 1 in FIG. 4.

The first step is to first of all produce a cover sheet 11 forming the visible layer, a first foam under-layer 13, a second foam under-layer 14 and a rigid core member 3, using conventional techniques.

As illustrated in particular in FIG. 1, the cover sheet 13 and the two foam under-layers 14 and 15 are here intimately joined together to form a structure 7 by a likewise conventional technique which may notably consist in localised flaming or in adhesive bonding by heating a powder glue disposed therebetween. The structure 7 furthermore here comprises a hook-and-loop layer 15 designed to promote adhesion between the structure 7 and the core member 3.

The first foam under-layer 13 is interposed between the cover sheet 11 and the second foam under-layer 14. It comprises chiefly open cells and in particular it is advantageously produced essentially from polyurethane. Its thickness prior to localised flaming or heating is advantageously comprised between 1 millimetre and 3 millimetres.

The second foam under-layer 14 comprises essentially closed cells and in particular it is advantageously produced essentially from thermoplastic polyolefin material(s) such as polyethylene and polypropylene. Its thickness is advantageously between 1 millimetre and 5 millimetres.

The cover sheet 11 is made from a textile material, non-woven or similar.

In FIG. 1, the structure 7 and in particular the second foam under-layer is heated, here by infra-red means 9 to between approximately 200° C. and 250° C.

As illustrated in FIG. 2, the structure 7 and the core member 5 are next arranged in an assembly mould 17 comprising a female mould section 17a and a male mould section 17b.

The cover sheet 11 comes up against a surface 17′a of one part of the mould, here the female mould section 17a.

The structure 7 may be arranged on a frame in order to transfer it to the mould 17 and/or to hold it in position (if necessary under tension).

The core member 3 is shown here in its final shape. This is a panel, or equivalent support having a mechanical function of stiffening the finished part, otherwise a carrier vis-à-vis the other elements to which it will be joined.

The core member 3 was obtained by injection, in a mould which has given it its final shape. In particular it may be made of plastic, a thermoplastic to be precise (for instance polypropylene) or else a composite material (for instance thermoplastic+wood fibres). One of its faces is covered here with a layer of adhesive 5, in particular a layer of heat-activated glue.

The core member 3 makes contact with a surface 17′b of the male mould section 17b, and the adhesive layer 5 comes up against the second foam under-layer 14 and the hook-and-loop sheet 15.

The mould is now closed, as illustrated in FIG. 3. The different layers 11, 13, 14, 15 of the structure and the core member are then pressed against one another, and this produces the shaping of the cover sheet 11, the foam under-layers 13, 14 and the hook-and-loop sheet 15. Besides, the structure 7, and to be specific the second under-layer 14, is now joined to the core member 3 via the hook-and-loop sheet 15 and the adhesive layer 5.

After cooling and removal from the mould, the part 1 illustrated in FIG. 4 is obtained.

FIG. 5 shows a variant of the process. The structure 3 is arranged in an injection mould 27 which incorporates a cavity 29 situated between a female mould section 27a and a male mould section 27b.

The cover sheet 11 comes up against a surface 27′a of the female mould section 27a.

Here, too, the structure 7 may be arranged on a frame in order to transfer it to the mould 27 and/or to hold it (preferably under tension).

Next the mould is closed, thereby causing the cover sheet 11 and the foam under-layers 13, 14 to be shaped.

A plastic designed to form the core member 3 is injected at low pressure (between 40 and 120 bars) into the moulding cavity 29, between the second foam under-layer 14, to be more precise the hook-and-loop sheet here forming the barrier 15, and the surface 27′b, via a plurality of nozzles 25 connected to an injection channel 26.

The plastic 23 is injected, advantageously in sequence, through the nozzles 25 until the moulding cavity 29 is filled with plastic.

The injected plastic presses against the second foam under-layer 14, continues the shaping of the structure 7 and becomes joined thereto by the agency of the barrier 15.

Once injection is completed, compressive stress can be applied in order to improve the appearance of the finished part.

The part obtained is then removed from the mould after cooling.

As will be readily understood, the foregoing embodiments are only examples of embodiments under the invention and are not to be construed as limiting the scope thereof.

Accordingly, the core member 3 could be inserted into the mould 17 in the form of a plate and be shaped as the mould is being closed.

It would also be possible to join some or all of the layers 11, 13, 14 which make up the structure 7 to one another inside the mould 17.

It would be possible to use more than one open-cell foam layer 13 and/or more than one closed-cell foam layer.

It would also be possible to replace the hook-and-loop sheet 15 and/or the layer 5 with other means that do the same job.

1. Vehicle interior trim element (1) comprising:
a rigid core member (3) which gives the element its shape,
a cover sheet (11) made of fabric or similar which covers the rigid core member,
a layer of foam (13, 14) arranged between the rigid core member and the cover sheet, sub-divided into a first and a second under-layer which are respectively arranged between the cover sheet and the second under-layer, and between the core member and the first under-layer, characterised in that:
the first under-layer (13) has mainly open cells, and
the second under-layer (14) has mainly closed cells and is produced essentially from thermoplastic polyolefin material(s).

2. Trim element as claimed in claim 1, characterised in that the first foam under-layer (13) is produced essentially from polyurethane.

3. Trim element as claimed in either of the preceding claims, characterised in that the first foam under-layer has a thickness comprised between 1 millimetre and 3 millimetres.

4. Process for producing a vehicle interior trim element, comprising the following steps:
a) producing a structure comprising a cover sheet (11), a first foam under-layer (13) having mainly open cells, and a second foam under-layer (14) having mainly closed cells,
b) arranging the first foam under-layer (13) in a mould (17, 27), between the cover sheet (11) and the second foam under-layer (14),
c) shaping the cover sheet, the first and the second foam under-layers by closing the mould,
d) joining the cover sheet, the first and the second foam under-layers with a rigid core member (3),
characterised in that during step a) a structure is produced of which the second foam under-layer is essentially made of thermoplastic polyolefin material(s).

5. Process as claimed in claim 4, characterised in that in order to carry out steps b), c) and d), the following steps are carried out in turn:
producing the core member beforehand,
arranging the core member in the mould (17), facing the second foam under-layer,
pressing on the cover sheet, the first foam under-layer, the second foam under-layer, and the core member, in order to shape them all and join them together.

6. Process as claimed in claim 5, characterised in that the core member is substantially given its final shape prior to arranging it in the mould.

7. Process as claimed in claim 4, characterised in that in order to carry out steps c) and d), the following steps are carried out in turn:
arranging the structure in the mould (27),
at least partially closing the mould,
injecting plastic at low pressure against the second foam under-layer, via a plurality of nozzles (25).

8. Process as claimed in any of claims 4 to 7, characterised in that prior to step c), the second foam under-layer (14) is exposed to a source of heat (9) in order to soften it.

9. Process as claimed in any of claims 4 to 8, characterised by joining together the cover sheet, and the first and second foam under-layers, prior to step b).

10. Process as claimed in any of claims 4 to 9, characterised in that during step a) a structure is produced of which the first foam under-layer (13) is essentially made of polyurethane.
